(19) United States
(12) Patent Application Publication
(10) Pub. No.: US 2026/0330131 A1
(43) Pub. Date: Oct. 22, 2026

(54) TABLE DATA PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Jialu LIN, Beijing (CN); Yongsen FENG, Beijing (CN)

(21) Appl. No.: 19/109,502

(22) PCT Filed: Feb. 5, 2024
(86) PCT No.: PCT/CN2024/076108

§ 371 Date: Mar. 6, 2025

(30) Foreign Application Priority Data
Feb. 15, 2023 (CN) 202310159186.4

(51) Int. Cl. G06F 40/177; G06F 40/134

(52) U.S. Cl. CPC G06F 40/177; G06F 40/134

(57) ABSTRACT

Disclosed herein are a table data processing method and apparatus, an electronic device, and a storage medium. The method includes: in response to a first preset operation of a user for a first cell in an online document, displaying at least one update record of the first cell; and in response to a second preset operation of the user for a first update record, obtaining an entity update content corresponding to the first update record. Therefore, a user can restore or copy accurately and completely the entity update content including the rich element, without being restricted to obtaining the text content corresponding to the update record.

### CROSS-REFERENCE TO RELATED APPLICATION(S)

The present disclosure claims the priority to the Chinese patent application No. 202310159186.4 entitled “EXCEL DATA PROCESSING METHOD AND APPARATUS, ELECTRONIC DEVICE, AND STORAGE MEDIUM” filed on Feb. 15, 2023, the content of which is hereby incorporated by reference in its entirety.

### FIELD

The present disclosure relates to the technical field of computers, and more specifically, to a table data processing method and apparatus, an electronic device, and a storage medium.

### BACKGROUND

The document collaboration technology can enable multiple users to deal with the same document in real time while not requiring the users to transfer documents to one another before processing. In the table collaboration process, after a content of a certain cell has been updated multiple times, a user may expect to restore or obtain (e.g. copy) the updated content of a certain version in some circumstances.

### SUMMARY

This Summary is provided to introduce a selection of concepts in a simplified form that are further described below in the Detailed Description. This Summary is not intended to identify key features or essential features of the claimed technical solution, nor is it intended to be used to limit the scope of the claimed technical solution.

In a first aspect, according to one or more embodiments of the present disclosure, there is provided a table data processing method, comprising:
in response to a first preset operation of a user for a first cell in an online document, displaying at least one update record of the first cell; and
in response to a second preset operation of the user for a first update record in the at least one update record, obtaining an entity update content corresponding to the first update record, wherein the entity update content of the first update record comprises a rich element comprising at least one of the following: a picture, a document, a hyperlink, or a function module.

In a second aspect, according to one or more embodiments of the present disclosure, there is provided a table data processing apparatus, comprising:
a displaying unit configured to display, in response to a first preset operation of a user for a first cell in an online document, at least one update record of the first cell; and
an obtaining unit configured to obtain, in response to a second preset operation of the user for a first update record in the at least one update record, an entity update content corresponding to the first update record, wherein the entity update content of the first update record comprises a rich element comprising at least one of the following: a picture, a document, a hyperlink, or a function module.

In a third aspect, according to one or more embodiments of the present disclosure, there is provided an electronic device, comprising: at least one memory and at least one processor; wherein the memory is configured to store program code, and the processor is configured to call the program code stored in the memory to cause the electronic device to perform the table data processing method provided according to one or more embodiments of the present disclosure.

In a fourth aspect, according to one or more embodiments of the present disclosure, there is provided a non-transitory computer storage medium, wherein the non-transitory computer storage medium stores program code that causes, when executed by a computer device, the computer device to perform the table data processing method provided according to one or more embodiments of the present disclosure.

According to one or more embodiments of the present disclosure, in response to a first preset operation of a user for a first cell in an online document, at least one update record of the first cell is displayed; and in response to a second preset operation of the user for a first update record, an entity update content corresponding to the first update record is obtained. Therefore, a user can restore or copy accurately and completely the entity update content including the rich element, without being restricted to obtaining the text content corresponding to the update record.

### BRIEF DESCRIPTION OF THE DRAWINGS

In conjunction with the drawings and with reference to the following implementations, the above and other features, advantages, and aspects of various embodiments of the present disclosure will be made more apparent. Throughout the drawings, the same or similar reference symbols represent the same or similar components. It would be appreciated that the drawings are provided illustratively, where the components and elements are not necessarily drawn to scale.

FIG. 1 illustrates a flowchart of a table data processing method provided according to an embodiment of the present disclosure;

FIG. 2 illustrates an update record interface of a cell provided according to an embodiment of the present disclosure;

FIG. 3 illustrates a schematic diagram of a structure of a table data processing apparatus provided according to an embodiment of the present disclosure; and

FIG. 4 illustrates a schematic diagram of a structure of an electronic device provided according to an embodiment of the present disclosure.

### DETAILED DESCRIPTION OF EMBODIMENTS

Reference now will be made to the drawings to describe in detail the embodiments of the present disclosure. Although some embodiments of the present disclosure are depicted in the drawings, the present disclosure could be implemented in various forms, which should not be construed as being limited to those embodiments illustrated herein. Rather, those embodiments are provided to enable a more thorough and complete understanding on the present disclosure. It would be appreciated that the drawings and embodiments of the present disclosure are provided exemplarily, without suggesting any limitation to the protection scope of the present disclosure.

It is to be understood that respective steps in the implementations of the method according to the present disclosure may be performed in different orders, and/or performed in parallel. In addition, the method implementations may include additional steps, and/or omit the shown steps. The scope of the present disclosure is not limited in the aspect.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” The term “in response to” and related terms refer to a signal or event being affected to some degree by another signal or event, but not necessarily completely or directly. If event x occurs “in response to” event y, then x may respond directly or indirectly to y. For example, the presence of y may eventually lead to the presence of x, but there may be other intermediate events and/or conditions. In other cases, y may not necessarily lead to the occurrence of x, and x may occur even though y has not yet occurred. In addition, the term “in response to” may also mean “at least partially in response to.”

As used herein, the term “determining” encompasses a wide variety of actions. For example, “determining” can include obtaining, calculating, computing, processing, deriving, investigating, looking up (e.g. looking up in a table, a database, or another data structure), ascertaining, and the like. Moreover, “determining” may include receiving (e.g., receiving information), accessing (e.g. accessing data in a memory) and the like. Further, “determining” may include resolving, selecting, choosing, establishing, and the like. Related definitions of other terms will be provided in the description below.

The data (including data per se, and acquisition or application of the data) involved in the present technical solution should comply with the provisions of the corresponding laws and regulations as well as relevant stipulations.

Prior to applying the technical solution according to various embodiments of the present disclosure, the user should be informed of the type, scope of use, and use scenario of the personal information involved in an appropriate manner, and user authorization should be obtained. For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

It should be noted that, the terms “first,” “second,” and the like mentioned herein are only used to distinguish different apparatuses, modules, or units, rather than limit an order of functions performed by the apparatus, module or unit or limit interdependence.

It should be noted that, the terms “one” and “a plurality of” mentioned in the present disclosure are illustrative, not restrictive, and should be understood as “one or more” by those skilled in the art, unless explicitly specified otherwise in the context.

To make the objective of the present disclosure clear, the phrase “A and/or B” may represent (A), (B), or (A and B).

Names of messages or information interacted between a plurality of apparatuses in the embodiments of the present disclosure are illustrative, rather than limit the scope of the messages or information.

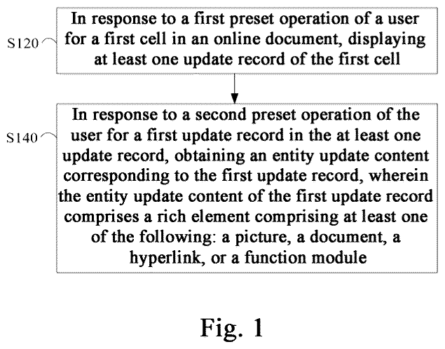

FIG. 1 illustrates a flowchart of a table data processing method 100 provided according to an embodiment of the present disclosure. The method 100 includes steps S120-S140.

Step S120: in response to a first preset operation of a user for a first cell in an online document, displaying at least one update record of the first cell; and

Step S140: in response to a second preset operation of the user for a first update record in the at least one update record, obtaining an entity update content corresponding to the first update record.

The entity update content of the first update record includes a rich element including at least one of the following: a picture, a document, a hyperlink, or a function module. In some embodiments, the function module is used to perform a preset function of, for example, a calendar reminder, a user reminder, a document reminder, or the like, for a table.

In some embodiments, the online document may be a document allowing a user to perform online editing and collaboration with other users and saved in a cloud, which can be displayed through, for example, a Hyper Text Markup Language (HTML) page, and can be synchronized with the content edited by the user depending on the communication between the client and the server.

In some embodiments, the performer of the method 100 may be a client, for example, an Instant Message (IM) client. The client is integrated with the function of the online document. In response to the user's click operation, the client calls a browser kernel through an interface provided by the browser, to load the page of the online document. Based on the loaded page, the user can create and edit the online document. Of course, the user can share the online document via the client. In some other embodiments, the client is integrated with a browser kernel, where the page of the online document can be displayed in the client by calling the browser kernel. In still some other embodiments, there exists an applet having a corresponding function of the online document. The client can download and display the page of the online document by downloading and running source code of the online document applet.

In response to a first preset operation for a first cell, an update record of the first cell is displayed. In some embodiments, the first preset operation includes, but is not limited to, a somatosensory control operation, a gesture control operation, an eye movement operation, a touch operation, a voice control command, or an operation for an external control device. By way of example, after selecting the first cell, the user can invoke, through the right mouse button, a preset menu that can provide a function option of viewing a cell update record, to allow the user to make further selection; after the user clicks the function option, the update record interface of the cell props up.

In response to a second preset operation for a first update record, an entity update content corresponding to the first update record is obtained. In some embodiments, the second preset operation includes, but is not limited to, a somatosensory control operation, a gesture control operation, an eye movement operation, a touch operation, a voice control command, or an operation for an external control device. By way of example, in response to that a preset virtual button corresponding to the first update record is triggered by the user, the entity update content corresponding to the first update record can be obtained.

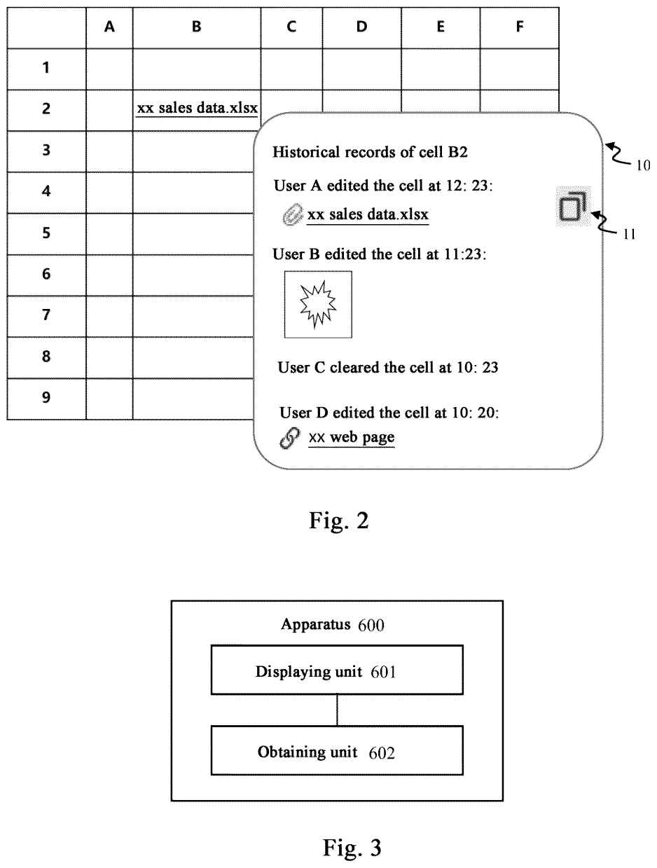

FIG. 2 illustrates an update record interface of a cell provided by an embodiment of the present disclosure. The update record interface 10 displays update records of a cell B2, which includes 4 update records of the cell B2 that sequentially display updates performed by a user A, a user B, a user C, and a user D in the form of a list. The displayed content of each update record includes a user name, an update time, and a detailed update content. Referring to FIG. 2, if the update content includes a document inserted into the cell as an attachment, the document name (e.g. “xx sales data”) of the attachment can be displayed in the corresponding update record; if the update content includes a picture inserted into the cell, a thumbnail of the picture can be displayed in the corresponding update record; if the update content includes a hyperlink inserted into the cell, the user-defined name of the hyperlink (e.g. “xx web page”) can be displayed in the corresponding update record.

The update record interface 10 currently displays a copy mark 11. Upon triggering the copy mark 11, the user can obtain the table document named “xx sales data” as the entity update content of the cell B2, rather than only the document name “xx sales data” of the table document presented in the cell B2.

In some embodiments, a plurality of update records can also be displayed in the update record interface in the form of turning pages, but the present disclosure is not limited thereto.

It is worth noting that the first cell may be any cell or a preset cell in the online document, which is not limited herein.

In addition to filling a cell with a text content, the online table can provide a rich-element insertion function of, for example, inserting a picture, a document, a hyperlink, a function module, or the like, into the cell. Through research, the inventor has found that the related online document cannot restore the update record of the rich element, resulting in a loss of such data if the rich element data of the cell is changed.

To this end, according to one or more embodiments, in response to a first preset operation of a user for a first cell in an online document, at least one update record of the first cell is displayed; and in response to a second preset operation of the user for a first update record, an entity update content corresponding to the first update record is obtained. Therefore, a user can restore or copy accurately and completely the entity update content including the rich element, without being restricted to obtaining the text content corresponding to the update record.

In some embodiments, step S140 includes: obtaining stored data corresponding to the rich element; and generating a cut content supporting cell paste, based on the stored data corresponding to the rich element, and an associated text or hyperlink of the rich element.

In some embodiments, in response to determining that the rich element is a document, the cut content supporting cell paste is generated based on the stored data corresponding to the rich element and the associated text of the rich element; or in response to determining that the rich element is any of a picture, a hyperlink, or a function module, the cut content supporting cell paste is generated based on the stored data corresponding to the rich element and the hyperlink of the rich element.

In some embodiments, the stored data is saved in a label attribute of a cell label for data extraction when pasting the cut content; and the associated text is embedded into the cell label such that the associated text is used as a text representation of the rich element which is pasted.

In some embodiments, the stored data is saved in a label attribute of a cell label, for data extraction when pasting the cut content; and a label defining a hyperlink is embedded into the cell label, and a hyperlink corresponding to the rich element is written in an attribute of an address of a hyperlink target specified in the label defining the hyperlink.

In some embodiments, the stored data corresponding to the rich element are data of a non-plain text data structure; the cell label is a standard cell label in a Hyper Text Markup Language (HTML) table; the label attribute includes an HTML label attribute.

In a specific implementation, the stored data corresponding to the rich element, for example, data stored in the form of SegmentArray, is saved in an attribute (e.g. data-sheet-value attribute) of the cell label (e.g. td label) allowing pasting and extraction, to facilitate data extract when pasting is performed; a corresponding label or text is embedded in the label to be displayed in the form when pasted; a Hyper Text Markup Language (HTML) string identifiable when pasted in the table is finally generated, which can be written in the clipboard in the HTML form. By way of example, if the rich element is a document, the document name is embedded in the td label. As such, the pasted rich element can be displayed in the cell in the form of the document name, and the user can acquire and view the content of the document upon clicking the document name displayed in the cell, instead of only the document name being displayed in the copied cell in the form of plain text. If the rich element is a picture, a hyperlink, or a function module, a label (e.g. label a) defining a hyperlink is embedded into the cell label, and a hyperlink corresponding to the rich element is written in an attribute (e.g. href attribute) of a URL of a hyperlink target specified in the label defining the hyperlink, such that, after performing pasting, the user can directly click the corresponding cell to view the content of the rich element through the hyperlink.

In some embodiments, the method 100 further includes: in response to a third preset operation for the first update record in the at least one update record, displaying a content preview interface of the rich element.

The third preset operation includes, but is not limited to, a somatosensory control operation, a gesture control operation, an eye movement operation, a touch operation, a voice control command, or an operation for an external control device. By way of example, in response to that the user triggers the first update record, or the representation (e.g. name) of the rich element in the first update record, the content preview interface of the rich element can be displayed. For example, if the rich element is a document, the user can preview the content of the document through the third preset operation.

In some embodiments, the method 100 further includes: after obtaining the entity update content corresponding to the first update record and in response to a fourth preset operation of the user, updating a content of a target cell in the online document with the entity update content corresponding to the first update record. Wherein, the fourth preset operation is used to update the content of the target cell to the obtained entity update content, which includes, but is not limited to, a somatosensory control operation, a gesture control operation, an eye movement operation, a touch operation, a voice control command, or an operation for an external control device. The target cell may include a first cell, or other cell than the first cell, which is not limited herein. In those embodiments, by updating the content of the target cell in the online document to the entity update content in response to the fourth preset operation of the user, the rich element can be pasted and restored within the cells.

Correspondingly, referring to FIG. 3, there is provided a table data processing apparatus 600 according to an embodiment of the present disclosure, comprising:
a displaying unit 601 configured to display, in response to a first preset operation of a user for a first cell in an online document, at least one update record of the first cell; and
an obtaining unit 602 configured to obtain, in response to a second preset operation of the user for a first update record in the at least one update record, an entity update content corresponding to the first update record, wherein the entity update content of the first update record comprises a rich element comprising at least one of the following: a picture, a document, a hyperlink, or a function module.

In some embodiments, the obtaining unit is further configured to generate a cut content supporting cell paste based on stored data corresponding to the rich element, and an associated text or hyperlink of the rich element.

In some embodiments, the obtaining unit includes:
a first obtaining sub-unit configured to generate, in response to determining that the rich element is a document, the cut content supporting cell paste based on the stored data corresponding to the rich element and the associated text of the rich element; or
a second obtaining sub-unit configured to generate, in response to determining that the rich element is any of a picture, a hyperlink, or a function module, the cut content supporting cell paste based on the stored data corresponding to the rich element and the hyperlink of the rich element.

In some embodiments, the associated text is used as a text representation of the rich element which is pasted; and the hyperlink is used to view a text content of the rich element.

In some embodiments, the associated text comprises a name of the rich element.

In some embodiments, the displaying unit is configured to display, in response to determining that an update content in the at least one update record comprises a picture, a thumbnail of the picture.

In some embodiments, the table data processing apparatus further includes:
a preview unit configured to display, in response to a third preset operation for the first update record in the at least one update record, a content preview interface of the rich element.

In some embodiments, the table data processing apparatus further includes:
a cell updating unit configured to update a content of a target cell in the online document with the entity update content corresponding to the first update record, after obtaining the entity update content corresponding to the first update record and in response to a fourth preset operation of the user

In some embodiments, the first obtaining sub-unit is further configured to: save the stored data in a label attribute of a cell label for data extraction when pasting the cut content; and embed the associated text into the cell label such that the associated text is used as a text representation of the rich element which is pasted.

In some embodiments, the second obtaining sub-unit is further configured to: save the stored data in a label attribute of a cell label, for data extraction when pasting the cut content; and embed a label defining a hyperlink into the cell label, and write a hyperlink corresponding to the rich element in an attribute of an address of a hyperlink target specified in the label defining the hyperlink. For the apparatus embodiments substantially corresponding to the method embodiments, see the related description about the method embodiments. The apparatus embodiments described above are provided only exemplarily, and the modules illustrated therein as separate modules may, or may not, be separated. As actually required, a part or all of the modules can be selected to accomplish the objective of the solution according to the embodiments. Those skilled in the art could understand and carry out the solution, without doing creative work.

Correspondingly, according to one or more embodiments of the present disclosure, there is provided an electronic device, including:
at least one memory and at least one processor;
where the memory is configured to store program code, and the processor is configured to call the program code stored in the memory to cause the electronic device to perform the table data processing method provided according to one or more embodiments of the present disclosure.

Correspondingly, according to one or more embodiments of the present disclosure, there is provided a non-transitory computer storage medium, where the non-transitory computer storage medium stores program code that causes, when executed by a computer device, the computer device to perform the table data processing method provided according to one or more embodiments of the present disclosure.

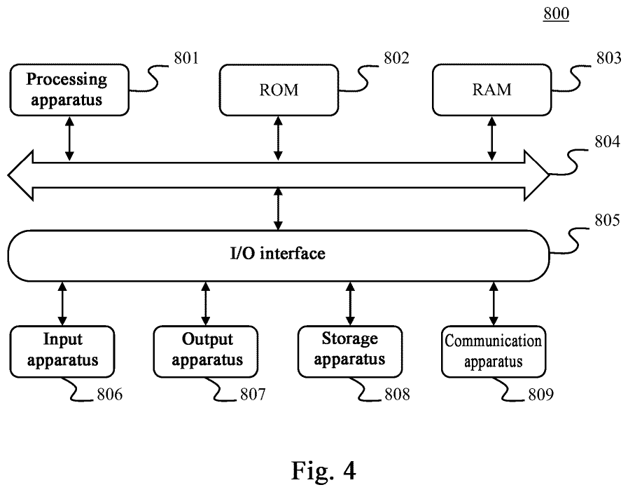

FIG. 4 illustrates a schematic diagram of an electronic device (e.g. a terminal device, or a server) 800 adapted to implement an embodiment of the present disclosure. The terminal device according to the embodiment of the present disclosure may include, but is not limited to, a mobile terminal such as a mobile phone, a laptop computer, a digital broadcast receiver, a Personal Digital Assistant (PDA), a tablet computer (PAD), a Portable Multimedia Player (PMP), an on-vehicle terminal (e.g. an on-vehicle navigation terminal), or the like, or a fixed terminal such as a digital TV, a desktop computer, or the like. The electronic device as shown in FIG. 4 is only an example, without suggesting any limitation to the functions and the application range of the embodiments of the present disclosure.

As shown therein, the electronic device 800 may include a processing (e.g. a central processor, a graphics processor or the like) 801, which can execute various acts and processing based on programs stored in a Read-Only Memory (ROM) 802 or a program loaded from a storage apparatus 808 to a Random Access Memory (RAM) 803. RAM 803 stores therein various programs and data required for operations of the electronic device 800. The processing apparatus 801, the ROM 802, and the RAM 803 are connected to one another via a bus 804. An input/output (I/O) interface 805 is also connected to the bus 804.

Typically, the following units may be connected to the I/O interface 805: an input apparatus 806 including, for example, a touchscreen, a touch pad, a keyboard, a mouse, a camera, a microphone, an accelerometer, a gyroscope, and the like; an output apparatus 807 including, for example, a Liquid Crystal Display (LCD), a loudspeaker, a vibrator, and the like; a storage apparatus 808 including, for example, a tape, a hard drive, and the like; and a communication apparatus 809. The communication apparatus 809 can allow wireless or wired communication of the electronic device 800 with other devices to exchange data. Although FIG. 4 shows the electronic device 800 including various units, it would be appreciated that not all of the units as shown are required to be implemented or provided. Alternatively, more or fewer units may be implemented or provided.

According to embodiments of the present disclosure, the processes described above with reference to the flowcharts may be implemented as computer software programs. For example, embodiments of the present disclosure include a computer program product comprising computer programs carried on a computer readable medium, where the computer programs containing program code are used for performing the methods as in the flowcharts. In those embodiments, the computer programs may be downloaded and installed from a network via the communication apparatus 809, or may be installed from the storage apparatus 808, or may be installed from the ROM 802. The computer programs, when executed by the processing apparatus 801, perform the above-described functions defined in the method according to the embodiments of the present disclosure.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a Random-Only Memory (ROM), an Erasable Programmable Read-Only Memory (EPROM or flash memory), an optical fiber, a portable Compact Disc Read-Only Memory (CD-ROM), an optical storage apparatus, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The examples of the communication network include a Local Area Network (LAN), a Wide Area Network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to implement the method according to the present disclosure, as described above.

Computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a Local Area Network (LAN) and a Wide Area Network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/modules do not formulate limitation to the units per se.

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

According to one or more embodiments of the present disclosure, there is provided a table data processing method, comprising: in response to a first preset operation of a user for a first cell in an online document, displaying at least one update record of the first cell; and in response to a second preset operation of the user for a first update record in the at least one update record, obtaining an entity update content corresponding to the first update record, wherein the entity update content of the first update record comprises a rich element comprising at least one of the following: a picture, a document, a hyperlink, or a function module.

According to one or more embodiments of the present disclosure, obtaining the entity update content corresponding to the first update record comprises: generating a cut content supporting cell paste based on stored data corresponding to the rich element, and an associated text or hyperlink of the rich element.

According to one or more embodiments of the present disclosure, generating the cut content supporting cell paste based on the stored data corresponding to the rich element, and the associated text or hyperlink of the rich element, comprises: in response to determining that the rich element is a document, generating the cut content supporting cell paste based on the stored data corresponding to the rich element and the associated text of the rich element; or in response to determining that the rich element is any of a picture, a hyperlink, or a function module, generating the cut content supporting cell paste based on the stored data corresponding to the rich element and the hyperlink of the rich element.

According to one or more embodiments of the present disclosure, the associated text is used as a text representation of the rich element which is pasted; and the hyperlink is used to view a text content of the rich element.

According to one or more embodiments of the present disclosure, the associated text comprises a name of the rich element.

According to one or more embodiments of the present disclosure, displaying the at least one update record of the first cell comprises: in response to determining that an update content in the at least one update record comprises a picture, displaying a thumbnail of the picture.

According to one or more embodiments of the present disclosure, the method further comprises: in response to a third preset operation for the first update record in the at least one update record, displaying a content preview interface of the rich element.

According to one or more embodiments of the present disclosure, the method further comprises: after obtaining the entity update content corresponding to the first update record and in response to a fourth preset operation of the user, updating a content of a target cell in the online document with the entity update content corresponding to the first update record.

According to one or more embodiments of the present disclosure, generating the cut content supporting cell paste based on the stored data corresponding to the rich element, and the associated text or hyperlink of the rich element, comprises: saving the stored data in a label attribute of a cell label for data extraction when pasting the cut content; and embedding the associated text into the cell label such that the associated text is used as a text representation of the rich element which is pasted.

According to one or more embodiments of the present disclosure, generating the cut content supporting cell paste based on the stored data corresponding to the rich element, and the associated text or hyperlink of the rich element, comprises: saving the stored data in a label attribute of a cell label, for data extraction when pasting the cut content; and embedding a label defining a hyperlink into the cell label, and writing a hyperlink corresponding to the rich element in an attribute of an address of a hyperlink target specified in the label defining the hyperlink. According to one or more embodiments of the present disclosure, there is provided a table data processing apparatus, comprising: a displaying unit configured to display, in response to a first preset operation of a user for a first cell in an online document, at least one update record of the first cell; and an obtaining unit configured to obtain, in response to a second preset operation of the user for a first update record in the at least one update record, an entity update content corresponding to the first update record, wherein the entity update content of the first update record comprises a rich element comprising at least one of the following: a picture, a document, a hyperlink, or a function module. According to one or more embodiments, there is provided a non-transitory computer storage medium, where: the non-transitory computer storage medium stores program code that causes, when executed by a computer device, the computer device to perform the table data processing method provided according to one or more embodiments of the present disclosure.

The description above only relates to preferred embodiments of the present disclosure and technical principles applied therein. It would be appreciated by those skilled in the art that the scope disclosed herein is not limited to the particular combination of features described above, but also encompasses other embodiments in which any combination of the features described above or their equivalents does not depart from the spirit of the disclosure. For example, the above features and (but not limited to) the features disclosed in this disclosure having similar functions are replaced with each other to form the technical solution.

Further, while operations are depicted in a particular order, this should not be understood as requiring that such operations be performed in the particular order shown or in sequential order. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A table data processing method, comprising:
in response to a first preset operation of a user for a first cell in an online document, displaying at least one update record of the first cell; and
in response to a second preset operation of the user for a first update record in the at least one update record, obtaining an entity update content corresponding to the first update record, wherein the entity update content of the first update record comprises a rich element comprising at least one of the following: a picture, a document, a hyperlink, or a function module.

2. The method of claim 1, wherein obtaining the entity update content corresponding to the first update record comprises:
generating a cut content supporting cell paste based on stored data corresponding to the rich element, and an associated text or hyperlink of the rich element.

3. The method of claim 2, wherein generating the cut content supporting cell paste based on the stored data corresponding to the rich element, and the associated text or hyperlink of the rich element, comprises at least one of the following:
in response to determining that the rich element is the document, generating the cut content supporting cell paste based on the stored data corresponding to the rich element and the associated text of the rich element; or
in response to determining that the rich element is any of the picture, the hyperlink, or the function module, generating the cut content supporting cell paste based on the stored data corresponding to the rich element and the hyperlink of the rich element.

4. The method of claim 2, wherein the associated text is used as a text representation of the rich element which is pasted; and the hyperlink is used to view a text content of the rich element.

5. The method of claim 2, wherein the associated text comprises a name of the rich element.

6. The method of claim 1, wherein displaying the at least one update record of the first cell comprises:
in response to determining that an update content in the at least one update record comprises a picture, displaying a thumbnail of the picture.

7. The method of claim 1, further comprising:
in response to a third preset operation for the first update record in the at least one update record, displaying a content preview interface of the rich element.

8. The method of claim 1, further comprising:
after obtaining the entity update content corresponding to the first update record and in response to a fourth preset operation of the user, updating a content of a target cell in the online document with the entity update content corresponding to the first update record.

9. The method of claim 2, wherein generating the cut content supporting cell paste based on the stored data corresponding to the rich element, and the associated text or hyperlink of the rich element, comprises:
saving the stored data in a label attribute of a cell label for data extraction when pasting the cut content; and
embedding the associated text into the cell label such that the associated text is used as a text representation of the rich element which is pasted.

10. The method of claim 2, wherein generating the cut content supporting cell paste based on the stored data corresponding to the rich element, and the associated text or hyperlink of the rich element, comprises:
saving the stored data in a label attribute of a cell label, for data extraction when pasting the cut content; and
embedding a label defining a hyperlink into the cell label, and writing a hyperlink corresponding to the rich element in an attribute of an address of a hyperlink target specified in the label defining the hyperlink.

11. (canceled)

12. An electronic device, comprising:
at least one memory; and
at least one processor;
wherein the at least one memory stores instructions thereon which, when executed by the at least one processor, cause the electronic device to:
in response to a first preset operation of a user for a first cell in an online document, display at least one update record of the first cell; and
in response to a second preset operation of the user for a first update record in the at least one update record, obtain an entity update content corresponding to the first update record, wherein the entity update content of the first update record comprises a rich element comprising at least one of the following: a picture, a document, a hyperlink, or a function module.

13. A non-transitory computer storage medium, wherein:
the non-transitory computer storage medium stores instructions thereon which, when executed by a processor, cause the processor to:
in response to a first preset operation of a user for a first cell in an online document, display at least one update record of the first cell; and
in response to a second preset operation of the user for a first update record in the at least one update record, obtain an entity update content corresponding to the first update record, wherein the entity update content of the first update record comprises a rich element comprising at least one of the following: a picture, a document, a hyperlink, or a function module.

14. The electronic device of claim 12, wherein the instructions to obtain the entity update content corresponding to the first update record comprise instructions to:
generate a cut content supporting cell paste based on stored data corresponding to the rich element, and an associated text or hyperlink of the rich element.

15. The electronic device of claim 14, wherein the instructions to generate the cut content supporting cell paste based on the stored data corresponding to the rich element, and the associated text or hyperlink of the rich element, comprise instructions to perform at least one of the following:
in response to determining that the rich element is the document, generate the cut content supporting cell paste based on the stored data corresponding to the rich element and the associated text of the rich element; or
in response to determining that the rich element is any of the picture, the hyperlink, or the function module, generate the cut content supporting cell paste based on the stored data corresponding to the rich element and the hyperlink of the rich element.

16. The electronic device of claim 14, wherein the associated text is used as a text representation of the rich element which is pasted; and the hyperlink is used to view a text content of the rich element.

17. The electronic device of claim 14, wherein the associated text comprises a name of the rich element.

18. The electronic device of claim 12, wherein the instructions to display the at least one update record of the first cell comprise instructions to:
in response to determining that an update content in the at least one update record comprises a picture, display a thumbnail of the picture.

19. The electronic device of claim 12, wherein the instructions further comprise instructions to:
in response to a third preset operation for the first update record in the at least one update record, display a content preview interface of the rich element.

20. The electronic device of claim 12, wherein the instructions further comprise instructions to:
after obtaining the entity update content corresponding to the first update record and in response to a fourth preset operation of the user, update a content of a target cell in the online document with the entity update content corresponding to the first update record.

21. The electronic device of claim 14, wherein the instructions to generate the cut content supporting cell paste based on the stored data corresponding to the rich element, and the associated text or hyperlink of the rich element, comprise instructions to:
save the stored data in a label attribute of a cell label for data extraction when pasting the cut content; and
embed the associated text into the cell label such that the associated text is used as a text representation of the rich element which is pasted.
